(19) United States
(12) Patent Application Publication
(10) Pub. No.: US 2022/0147850 A1
(43) Pub. Date: May 12, 2022

(54) HYPOTHESIS VERIFICATION APPARATUS, HYPOTHESIS VERIFICATION, AND COMPUTER-READABLE RECORDING MEDIUM

(71) Applicant: NEC Corporation, Minato-ku, Tokyo (JP)

(72) Inventors: Takuya KAWADA, Tokyo (JP); Daichi KIMURA, Tokyo (JP)

(73) Assignee: NEC Corporation, Minato-ku, Tokyo (JP)

(21) Appl. No.: 17/431,768

(22) PCT Filed: Feb. 21, 2019
(86) PCT No.: PCT/JP2019/006648

§ 371 Date: Aug. 18, 2021

(51) Int. Cl. G06N 5/04

(52) U.S. Cl. CPC G06N 5/048

(57) ABSTRACT

A hypothesis verification apparatus 100, includes a hypothesis generation unit 11 that derives hypothesis candidates having a logical formula leading to possible consequences from an observation data, a hypothesis integration unit 12 that integrate the logical formula of each of the hypothesis candidates to construct a logical formula set, and, when there are overlapping logical formula select only one of them, a hypothesis verification unit 13 that sets, when a logical formula including a first parameter and a second parameter is existing in the logical formula set, the logical formula as a target logical formula, and input the acquired value of the second parameter into the target logical formula, and on the other hand, when logical formula is not existing, but if a logical formula that has a value in advance or has a value obtained by inference knowledge is existing, determine truth or falsehood of the existing logical formula.

### TECHNICAL FIELD

The present invention relates to a hypothesis verification apparatus, a hypothesis verification method, and a program for realizing these. In particular, the present invention relates to the hypothesis verification apparatus, the hypothesis verification method, and the program for embodying a process by generating a hypothesis of the process leading to a certain result and verifying the generated hypothesis.

### BACKGROUND ART

Conventionally, a method called abductive inference or abduction has been known as a kind of logical reasoning. For example, for an abnormal state that occurs in an object, a manufacturing system, a running software program, etc., there are hypotheses based on several possibilities to reach that state. Abductive inference is a method of selecting a hypothesis that can best explain the relevant facts obtained from these hypotheses.

In general, abductive inference generates several hypothesis candidates, one of which is selected as the final solution hypothesis. Then, in many of the actual usage situations, the selected solution hypothesis is verified, and the solution hypothesis is modified or reselected according to the verification result. Here, an example of a system that utilizes abductive inference for a real problem will be described based on Patent Document 1. Patent Document 1 discloses a driving support system using abductive inference.

The driving support system disclosed in Patent Document 1 predicts possible dangers while driving a car from information obtained by observing the surroundings. In the driving support system disclosed in Patent Document 1, weighted abductive inference (see Non-Patent Document 1), which is a kind of abductive inference, is used.

Specifically, as shown in FIG. 13 of Patent Document 1, the driver assistance system disclosed in Patent Document 1 first accepts an observation with a cost obtained by converting observation information as observation data. The observation is a conjunction of literals of first-ordered logic. Next, the driving support system disclosed in Patent Document 1 generates some hypotheses (hypothesis candidates) representing danger based on the observation data by the abductive inference unit. Then, the system disclosed in Patent Document 1 selects the solution hypothesis with the lowest proof cost from the generated hypothesis candidates as the most likely risk

Subsequently, the driver assistance system disclosed in Patent Document 1 executes a physical simulation on an object related to the selected hypothesis candidate (danger), estimates a behavior of the object, and uses the estimation result as a new observation. After that, the abductive inference unit adds the new observation to the existing observation and executes the abductive inference again. As described above, according to the driving support system disclosed in Patent Document 1, it is possible to predict the danger in consideration of the behavior of the object by the physical simulation.

### LIST OF RELATED ART DOCUMENTS

### Patent Documents

Patent Document 1: Japanese Patent Laid-Open Publication No. 2016-91039

### Non-Patent Documents

Non-Patent Document 1: Hobbs, Jerry R., Mark Stickel, Douglas Appelt, and Paul Martin, “Interpretation as Abduction”, Artificial Intelligence, Vol. 63, Nos. 1-2, pp. 69-142, 1993.

### SUMMARY OF INVENTION

### Problems to be Solved by the Invention

As described above, in the driving support system disclosed in Patent Document 1, only one hypothesis candidate having the lowest proof cost is selected from the generated hypothesis candidates. However, in practice, there may be multiple hypothesis candidates that are equivalent, best, and have different configurations. Therefore, the unselected hypothesis candidates may actually be more appropriate than the selected hypothesis candidate. Therefore, the driving support system disclosed in Patent Document 1 has a limit in improving the accuracy of risk prediction.

On the other hand, it is considered that the above-mentioned problem can be solved by verifying all hypothesis candidates having the same best and different configurations one by one, but the driving support system disclosed in Patent Document 1 has no verification function and cannot verify all hypothesis candidates. Further, even if the driving support system disclosed in Patent Document 1 is provided with a verification function, which results in occurring another problem that the processing takes too much time when the verification is performed on all the solution hypotheses.

An example of the object of the present invention is to provide a hypothesis verification apparatus, a hypothesis testing method, and a computer-readable recording medium that solves the above problem and can reduce a possibility of selecting an erroneous hypothesis candidate without increasing a processing load in case of selecting a hypothesis candidate worthy of verification from a plurality of hypothesis candidates.

### Means for Solving the Problems

To achieve the aforementioned example object, a hypothesis verification apparatus, includes:

a hypothesis generation unit derives a plurality of hypothesis candidates having a logical formula leading to possible consequences from an observation data represented by a set of logical formulas including one name and one or more parameters by using a knowledge data expressed in the same format as the observation data,

a hypothesis integration unit integrates the logical formula of each of the hypothesis candidates to construct a logical formula set, and, when there are overlapping logical formula in the logical formula set, select only one of them and delete the rest,

a hypothesis verification unit sets, when a logical formula including a first parameter having a value obtained from the observation data and a second parameter having no value obtained from the observation data is existing in the logical formula set, the logical formula as a target logical formula, acquire a value of the second parameter based on the observation data and the name of the target logical formula, and input the acquired value of the second parameter into the target logical formula, and on the other hand, when logical formula to be set as the target logical formula is not existing, but if a logical formula that has a value for one or more parameters in advance or has a value obtained by inference knowledge for one or more parameters is existing, determine truth or falsehood of the existing logical formula,

wherein, when the truth or falsehood of the existing logical formula is determined, or the acquired value of the second parameter is input into the target logical formula, the hypothesis generation unit add the logical formula or the target logical formula to the observation data and derives the hypothesis candidates again.

Furthermore, to achieve the aforementioned example object, a hypothesis verification method, includes:

(a) a step of deriving a plurality of hypothesis candidates having a logical formula leading to possible consequences from an observation data represented by a set of logical formulas including one name and one or more parameters by using a knowledge data expressed in the same format as the observation data,

(b) a step of integrating the logical formula of each of the hypothesis candidates to construct a logical formula set, and, when there are overlapping logical formula in the logical formula set, selecting only one of them and deleting the rest,

(c) a step of setting, when a logical formula including a first parameter having a value obtained from the observation data and a second parameter having no value obtained from the observation data is existing in the logical formula set, the logical formula as a target logical formula, acquiring a value of the second parameter based on the observation data and the name of the target logical formula, and inputting the acquired value of the second parameter into the target logical formula, and

(d) a step of determining, when logical formula to be set as the target logical formula is not existing, but if a logical formula that has a value for one or more parameters in advance or has a value obtained by inference knowledge for one or more parameters is existing, truth or falsehood of the existing logical formula,

(e) a step of adding, when the truth or falsehood of the existing logical formula is determined, or the acquired value of the second parameter is input into the target logical formula, the logical formula or the target logical formula to the observation data and deriving the hypothesis candidates again.

Moreover, to achieve the aforementioned example object, a computer-readable recording medium in which a program is recorded, the program including an instruction that causes a computer to execute:

(a) a step of deriving a plurality of hypothesis candidates having a logical formula leading to possible consequences from an observation data represented by a set of logical formulas including one name and one or more parameters by using a knowledge data expressed in the same format as the observation data,

(b) a step of integrating the logical formula of each of the hypothesis candidates to construct a logical formula set, and, when there are overlapping logical formula in the logical formula set, selecting only one of them and deleting the rest,

(c) a step of setting, when a logical formula including a first parameter having a value obtained from the observation data and a second parameter having no value obtained from the observation data is existing in the logical formula set, the logical formula as a target logical formula, acquiring a value of the second parameter based on the observation data and the name of the target logical formula, and inputting the acquired value of the second parameter into the target logical formula, and

(d) a step of determining, when logical formula to be set as the target logical formula is not existing, but if a logical formula that has a value for one or more parameters in advance or has a value obtained by inference knowledge for one or more parameters is existing, truth or falsehood of the existing logical formula,

(e) a step of adding, when the truth or falsehood of the existing logical formula is determined, or the acquired value of the second parameter is input into the target logical formula, the logical formula or the target logical formula to the observation data and deriving the hypothesis candidates again.

### Advantageous Effects of the Invention

As described above, according to the present invention, a possibility of selecting an erroneous hypothesis candidate is reduced without increasing a processing load, in case of selecting a hypothesis candidate worthy of verification from a plurality of hypothesis candidates.

### BRIEF DESCRIPTION OF THE DRAWINGS

FIG. 1 is a block diagram showing a schematic configuration of a hypothesis verification apparatus according to an example embodiment.

FIG. 2 is a block diagram showing a specific configuration of the hypothesis verification apparatus according to the example embodiment.

FIG. 3 is a diagram showing an example of data stored in a consequential storage unit in the example embodiment.

FIG. 4 is a diagram showing an example of knowledge data used in the Example Embodiment

FIG. 5 is a diagram showing an example of integration process by the hypothesis integration unit according to the example embodiment.

FIG. 6 is a diagram showing another example of the integration process by the hypothesis integration unit according to the example embodiment.

FIG. 7 is a flow diagram showing operations of the hypothesis verification apparatus according to the example embodiment.

FIG. 8 is a flow diagram showing more specifically steps A6 to A9 shown in FIG. 7 in the example embodiment.

FIG. 9 is a diagram showing a content of the process in the first specific example according to the example embodiment.

FIG. 10 is a diagram showing a content of the process in the second specific example according to the example embodiment.

FIG. 11 is a block diagram showing an example of a computer that realizes the hypothesis verification apparatus according to the example embodiment.

### EXAMPLE EMBODIMENT

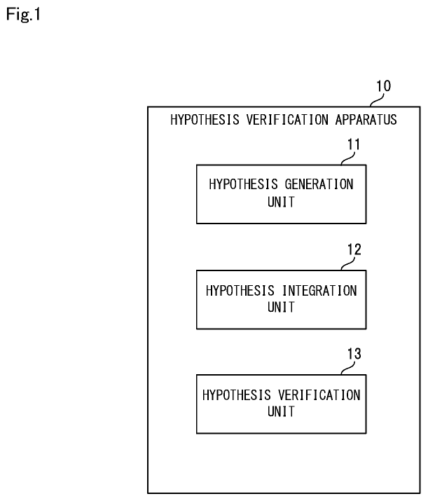

The following describes a hypothesis verification apparatus, a hypothesis verification method, and a program according to the example embodiment with reference to FIG. 1 to FIG. 11.

[Apparatus Configuration]

First, a schematic configuration of the hypothesis verification apparatus according to the example embodiment will be described. FIG. 1 is a block diagram showing a schematic configuration of a hypothesis verification apparatus according to an example embodiment.

The hypothesis verification apparatus 10 in the example embodiment shown in FIG. 1 is an apparatus that verifies hypothesis candidates generated from an observation data. As shown in FIG. 1, the hypothesis verification apparatus 10 includes a hypothesis generation unit 11, a hypothesis integration unit 12, and a hypothesis verification unit 13.

Of these, the hypothesis generation unit 11 derives a plurality of hypothesis candidates having a logical formula leading to possible consequences from the observation data represented by a set of logical formulas including one name and one or more parameters by using a knowledge data expressed in the same format as the observation data,

The hypothesis integration unit 12 integrates the logical formula of each of the hypothesis candidates to construct a logical formula set. When there are overlapping logical formula in the logical formula set, hypothesis integration unit 12 select only one of them and delete the rest.

when a logical formula including a first parameter having a value obtained from the observation data and a second parameter having no value obtained from the observation data is existing in the logical formula set, the hypothesis verification unit 13 first set the logical formula as a target logical formula. Next, the hypothesis verification unit 13 acquire a value of the second parameter based on the observation data and the name of the target logical formula, and input the acquired value of the second parameter into the target logical formula.

Further, when logical formula to be set as the target logical formula is not existing, but if a logical formula that has a value for one or more parameters in advance or has a value obtained by inference knowledge for one or more parameters is existing, the hypothesis verification unit 13 determine truth or falsehood of the existing logical formula.

Then, when the truth or falsehood of the existing logical formula is determined, or the acquired value of the second parameter is input into the target logical formula, by the hypothesis verification unit 13, the hypothesis generation unit add the determined logical formula or the target logical formula to the observation data and derives the hypothesis candidates again.

As described above, in the example embodiment, the plurality of hypothesis candidates is integrated to construct the logical formula set, and the logical formula set is verified.

Therefore, when selecting a hypothesis candidate worthy of verification from a plurality of hypotheses candidate, it is possible to reduce the possibility of selecting an erroneous hypothesis candidate without increasing a processing load.

Further, in the example embodiment, the hypothesis is derived again by using the result of the truth determination of the logical formula constituting the hypothesis or the logical formula to which a value of a new parameter is added. According to the example embodiment, the hypothesis can be verified, and the hypothesis can be modified based on the verification result.

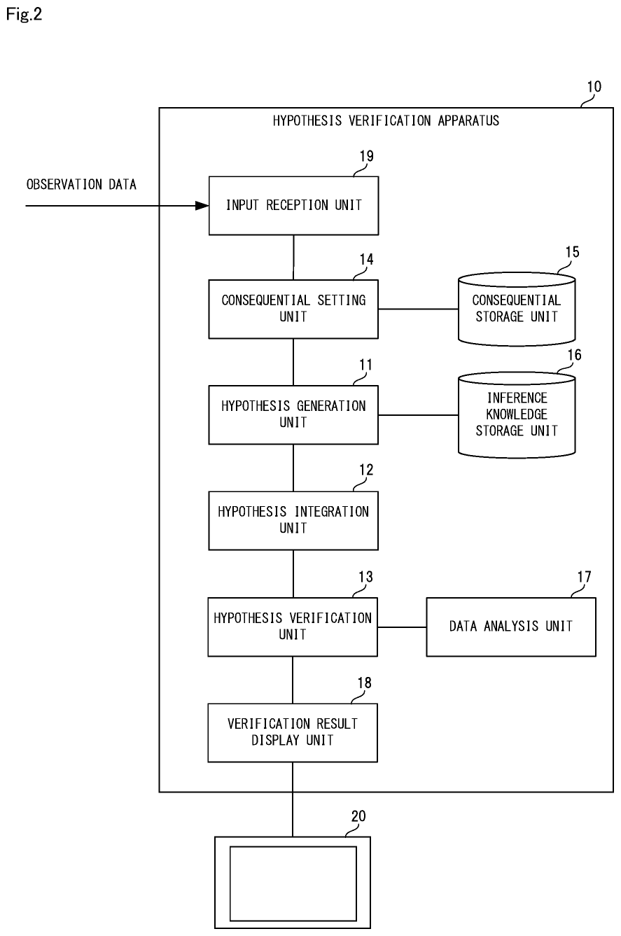

Subsequently, the configuration of the hypothesis verification apparatus 10 in the example embodiment will be described more specifically with reference to FIG. 2. FIG. 2 is a block diagram showing a specific configuration of the hypothesis verification apparatus according to the example embodiment.

As shown in FIG. 2, the hypothesis verification apparatus 10 in the example embodiment includes a consequential setting unit 14, a consequential storage unit 15, an inference knowledge storage unit 16, a data analysis unit 17, a verification result display unit 18, and an input reception unit 19 in addition to the hypothesis generation unit 11, the hypothesis integration unit 12, and the hypothesis verification unit 13 described above. Further, the hypothesis verification apparatus 10 is connected to a display device 20 such as a liquid crystal display device.

The input reception unit 19 receives input of an observation data from the outside. Further, in the example embodiment, the observation data is data expressed in the form of a logical formula, in which all parameters have values obtained by observing the event to be inferred. The input reception unit 19 passes the received observation data to the consequential setting unit 14.

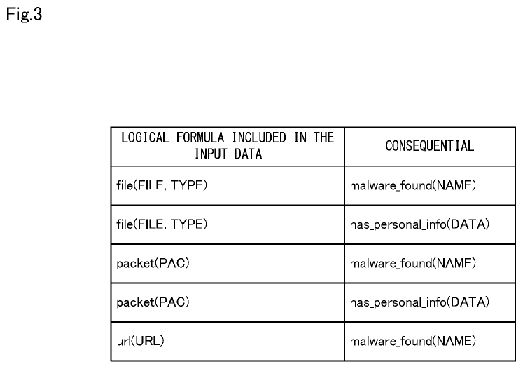

The consequential setting unit 14 collates the observation data with the consequential storage unit 15 and sets the consequent corresponding to the observation data. In addition, the set consequences serve as the starting point for abductive inference. The consequential storage unit 15 is a database in which consequents are registered in advance for each logical formula. FIG. 3 is a diagram showing an example of data stored in the consequential storage unit in the example embodiment. As shown in FIG. 3, the consequential storage unit 15 registers the consequents set for each logical formula.

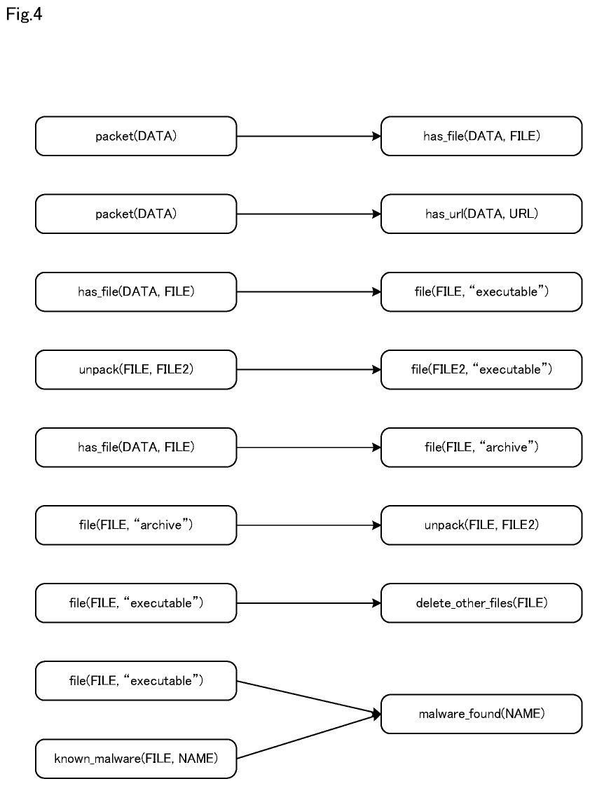

The inference knowledge storage unit 16 stores knowledge data used for deriving a hypothesis by the hypothesis generation unit 11. FIG. 4 is a diagram showing an example of knowledge data used in the example embodiment. As shown in FIG. 4, the knowledge data in the example embodiment is inference knowledge.

In the example embodiment, the hypothesis generation unit 11 performs abductive inference by using the observation data, the consequences set by the consequential setting unit 14, and the knowledge data stored in the inference knowledge storage unit 16 to derive the hypothesis candidate. Examples of the abductive inference method include weighted abductive inference, which is also used in Patent Document 1 described above.

Specifically, the hypothesis generation unit 11 uses the method disclosed in the above-mentioned Patent Document 1 and Non-Patent Document 1 to select the inference knowledge linked to the consequence set by the consequence setting unit 14 from the inference knowledge stored in the inference knowledge storage unit 16, and add the observation data to the selected inference knowledge. As a result, as many hypothesis candidates as the number of selected inference knowledges are generated.

Next, the hypothesis generation unit 11 selects the plurality of hypothesis candidates. The hypothesis candidates are a plurality of hypothesis such that it has each different configuration and evaluation value of each hypothesis candidates calculated by evaluation function is the same or best (see Documents 1 and 2 below). For example, the hypothesis generation unit 11 calculates a cost of each of the generated hypothesis candidates as an evaluation value by using a cost given to the observation data and a weight given to each inference knowledge. Then, the hypothesis generation unit 11 selects a plurality of hypothesis candidates having the lowest cost and different configurations. Hereinafter, such a method will be referred as a “K-best solution output method”.

Reference 1: “What's New in Gurobi7.0”,[online], 2016 Nov. 16, GUROBI OPTIMIZATION, <URL: http://www.gurobi.com/pdfs/webinars/gurobi-7.0-webinar-slides-de.pdf>
Reference 2: Jose A. Gamez, “Abductive Inference in Bayesian Networks”, [online], Springer Link, <URL: https://link.springer.com/chapter/10.1007/978-3-540-39879-0_6>

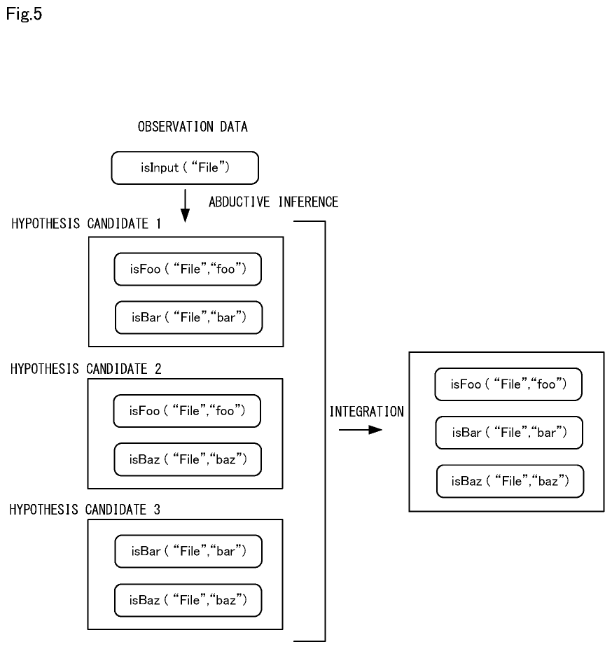

In the example embodiment, the hypothesis integration unit 12 integrates the logical formulas of each of the hypothesis candidates 1 to 3, as shown in FIG. 5, for example.

FIG. 5 is a diagram showing an example of integration processing by the hypothesis integration unit according to the example embodiment. In the example of FIG. 5, the logical formula of hypothesis candidates; “isFoo (“File”,“foo”)”, “isBar (“File”,“bar”)”, and “isBaz (“File”,“baz”))” are duplicated, so they are deleted.

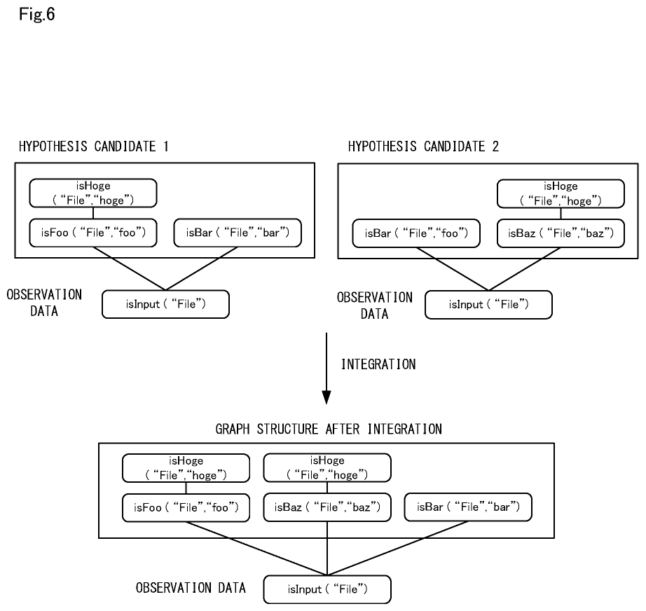

When the hypothesis generation unit 11 derives a hypothesis candidate composed of a graph structure, the hypothesis integration unit 12 constructs, based on the graph structure, a graph structure constituting the logical formula set after deleting the duplicated logical formulas, as shown in FIG. 6. That is, in this case, the hypothesis generation unit 11 executes the integration process in consideration of the graph structure. FIG. 6 is a diagram showing another example of the integration process by the hypothesis integration unit according to the example embodiment.

The data analysis unit 17 registers each logical formula the name of the logical formula and an analysis tool capable of extracting the values of the parameters included in the logical formula in association with each other for each logical formula. Then, when the name of the logical formula and the observed data, or the name of the logical formula and the value of the first parameter are input, the data analysis unit 17 executes the analysis tool in response to the input.

Further, as the analysis tool that can be used in the example embodiment, various known file analysis tools provided by the application program (including the web application program) can be mentioned.

In the present embodiment, the hypothesis verification unit 13 inputs the observation data and the name of the target logical formula into the data analysis unit 17, determinines the truth or falsehood of the target logical formula or acquires the value of the second parameter according to the output of analysis tool.

Specifically, in the example embodiment, the hypothesis verification unit 13 first determines whether or not a logical formula (target logical formula) having two or more parameters which only some of the parameters (first parameters) has a value exists in the logical formula set.

As a result of the determination, if the target logical formula corresponding to the condition exists, the hypothesis verification unit 13 uses this target logical formula as a search query. Subsequently, the hypothesis verification unit 13 searches the analysis tools registered by the data analysis unit 17 by using the search query and specified the analysis tool applicable to the search query from among these. Next, the hypothesis verification unit 13 causes the data analysis unit 17 to execute the specified analysis tool and acquires the value of the second parameter from the value of the first parameter of the target logical formula.

On the other hand, as a result of the above determination, when the target logical formula corresponding to the condition is not existing, but if logical formula having a value for one or more parameters in advance or having a value obtained by inference knowledge for one or more parameters is existing, as described above, the hypothesis verification unit 13 determines the truth or falsehood of this logical formula.

In the determination of truth or falsehood, for example, the analysis tool is executed for the parameter for which the value is set in advance, and the value is acquired. Then, if the acquired value is the same as the value set in the parameter in advance, it is true, and if it is different, it is false. Alternatively, in the determination of truth or falsehood, if the analysis tool is executed and it can be determined that the logical formula having the value obtained by the inference knowledge is satisfied, it is true, and if it can be determined that it is not satisfied, it is false. Further, the analysis tool in such a case is searched by using the logical formula that has the value for one or more parameters in advance or has the value obtained by inference knowledge for one or more parameters as a search query.

When the hypothesis verification unit 13 can acquire the value of the second parameter, the hypothesis generation unit 11 inputs the acquired value into the second parameter of the target logical formula as a value obtained by observing the event. Then, the hypothesis generation unit 11 adds the input target logical formula to the observation data and derives the hypothesis candidate again from the added observation data.

On the other hand, when the hypothesis verification unit 13 determines the truth or falsehood of the target logical formula, the hypothesis generation unit 11 reflects the result of the truth or falsehood determination in the logical formula to be determined. For example, if the result of the truth or falsehood determination is true, the hypothesis generation unit 11 does nothing with respect to the logical formula to be determined. On the other hand, if the result of the truth or falsehood determination is false, the hypothesis generation unit 11 substitutes the value obtained by executing the analysis data into the parameter having the predetermined value of the logical formula to be determined. Further, the hypothesis generation unit 11 sets the logical formula to which the value is substituted as a new logical formula. Alternatively, the hypothesis generation unit 11 may add a negative operator to the logical formula determined to be false. Specifically, the hypothesis generation unit 11 adds the negative operator “!” to the beginning of the file (foo.rar, “executable”), set “! file (foo.rar, “executable”)” as the observation data. Then, the hypothesis generation unit 11 adds the logical formula reflecting the result of the truth or falsehood determination to the observation data, and derives the hypothesis candidate again from the added observation data.

In the example embodiment, the derivation of the hypothesis candidate by the hypothesis generation unit 11, the integration of the hypothesis candidate, by the hypothesis integration unit 12, and the verification of the hypothesis candidate by the hypothesis verification unit 13 are repeated. Then, in case that there is no analysis tool applicable to any of the logical formulas that make up the hypothesis candidate, that is, all the logical formulas that make up the hypothesis candidate have values for all the parameters, the hypothesis generation unit 11 outputs this hypothesis candidate as a final hypothesis. Such a hypothesis consisting only of logical formulas having values for all parameters is completely verified and proved hypothesis.

The verification result display unit 18 displays the final hypothesis output by the hypothesis generation unit 11 on the screen of the display device 20 as the verification result. In the example of FIG. 2, the verification result is displayed on the screen of the display device 20 connected to the hypothesis verification apparatus 10. In the example embodiment, the verification result may be displayed on the screen of the terminal device connected to the hypothesis verification apparatus 10 via the network.

[Apparatus Operations]

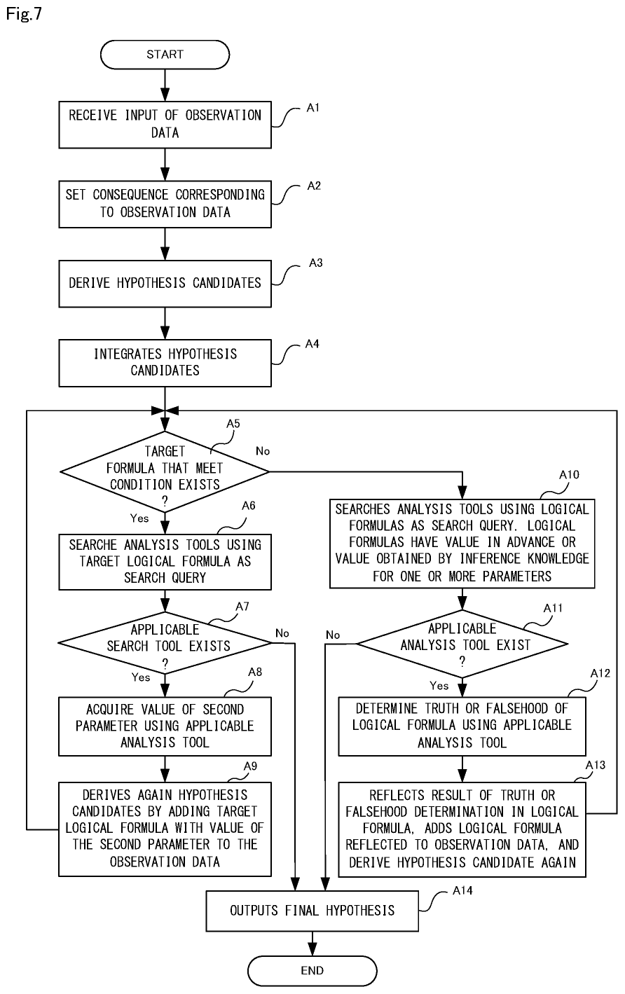

Next, the operations of the hypothesis verification apparatus 10 according to the first example embodiment will be described using FIG. 7. FIG. 7 is a flow diagram showing operations of the hypothesis verification apparatus according to the example embodiment. In the following description, FIG. 1 to FIG. 6 will be referred to as appropriate. Furthermore, in the first example embodiment, the hypothesis verification method is carried out by causing the hypothesis verification apparatus 10 to operate. Therefore, the following description of the operations of the hypothesis verification apparatus 10 applies to the hypothesis verification method according to the first example embodiment.

As shown in FIG. 7, first, the input reception unit 19 receives the input of the observation data from the outside (step A1). The input reception unit 19 passes the received observation data to the consequential setting unit 14.

Next, the consequential setting unit 14 collates the observation data with the consequential storage unit 15 (see FIG. 3) and sets the consequence corresponding to the observation data (step A2).

Next, the hypothesis generation unit 11 performs abductive inference by using the observation data, the consequences set by the consequential setting unit 14, and the inference knowledge stored in the inference knowledge storage unit 16 to derive the hypothesis candidates (step A3). Specifically, in step A3, the hypothesis generation unit 11 derives the plurality of hypothesis candidates. The hypothesis candidates are a plurality of hypothesis such that it has each different configuration and evaluation value of each hypothesis candidates calculated by evaluation function is the same or best using the K-best solution output method.

Next, when a plurality of hypothesis candidates is generated in step A3, the hypothesis integration unit 12 integrates the logical formula of each of the hypothesis candidates to construct a logical formula set. When there are overlapping logical formula in the logical formula set, hypothesis integration unit 12 select only one of them and delete the rest (step A4).

Next, the hypothesis verification unit 13 determines whether or not a logical formula (target logical formula) having two or more parameters which only some of the parameters (first parameters) has a value exists in the obtained logical formula set in the step A4 (step A5).

As a result of the determination in step A4, if the target logical formula corresponding to the condition exists, the hypothesis verification unit 13 searches the analysis tools registered by the data analysis unit 17 by using the target logical formula corresponding to the condition as a search query (step A6).

Next, the hypothesis verification unit 13 determines whether or not an applicable analysis tool can be searched by executing step A6 (step A7). If, as a result of the determination in step A7, the applicable analysis tool cannot be searched, the hypothesis verification unit 13 executes step A14.

On the other hand, if, as a result of the determination in step A7, the applicable analysis tool can be searched, the hypothesis verification unit 13 causes the data analysis unit 17 to execute the searched analysis tool, and acquires the value of the second parameter from the value of the first parameter of the target logical formula (step A8).

Next, after the execution of step A8, the hypothesis generation unit 11 inputs the acquired value to the second parameter of the target logical formula, adds the input target logical formula to the observation data. And the hypothesis generation unit 11 derives again hypothesis candidates from the observation data.

Further, as a result of the determination in step A5, if the target logical formula corresponding to the condition does not exist, on the condition that a specific logical formula exists, the hypothesis verification unit 13 searches the analysis tools registered by the data analysis unit 17 using the specific logical formula as a search query (step A10). The specific logical formula is a logical formula that has a value for one or more parameters in advance or a logical formula that has a value obtained by inference knowledge.

Next, the hypothesis verification unit 13 determines whether or not an applicable analysis tool can be searched by executing step A10 (step A11). If, as a result of the determination in step A11, the applicable analysis tool cannot be searched, the hypothesis verification unit 13 executes step A14.

On the other hand, if, as a result of the determination in step A11, the applicable analysis tool can be searched, the hypothesis verification unit 13 causes the data analysis unit 17 to execute the searched analysis tool, the hypothesis verification unit 13 determines the truth or falsehood of the logical formula having a value for one or more parameters in advance or having a value obtained by inference knowledge for one or more parameter (step A12).

Next, after the execution of step A12, the hypothesis verification unit 13 reflects the result of the truth or falsehood determination in the logical formula to be determined. And the hypothesis verification unit 13 adds the logical formula reflecting the result of the truth or falsehood determination to the observation data, then, derives the hypothesis candidate again from the added observation data (step A13). After that, step A5 is executed again.

If step A7 or step A11 determined “No”, the hypothesis generation unit 11 outputs the hypothesis candidate to be determined as the final hypothesis (step A13). After the execution of step A13, the verification result display unit 18 displays the final hypothesis output by step A13 on the screen as the verification result.

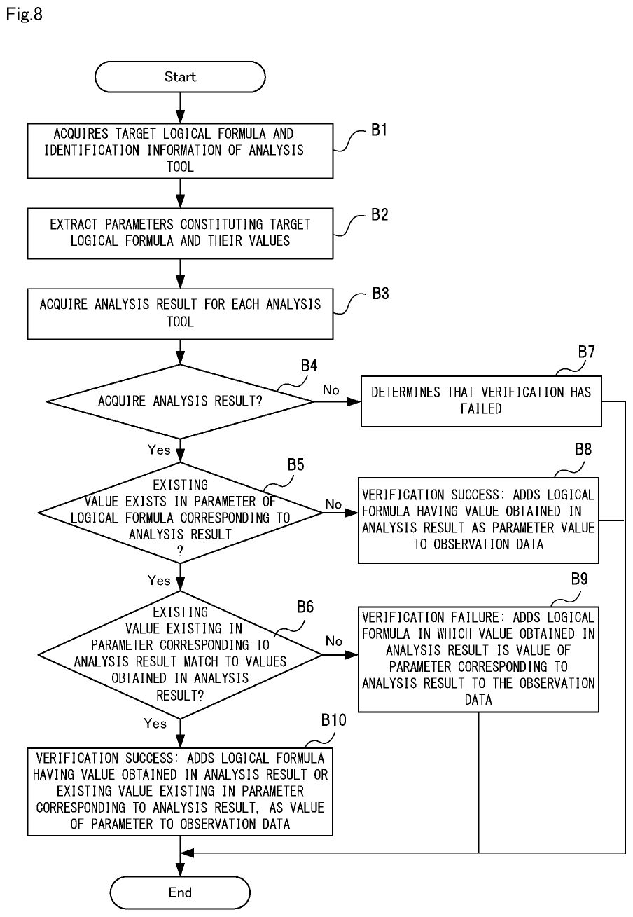

Here, steps A6 to A9 shown in FIG. 7 will be described more specifically with reference to FIG. 8. FIG. 8 is a flow diagram showing more specifically steps A6 to A9 shown in FIG. 7 in the example embodiment. When the processing is executed according to the flow shown in FIG. 8, the analysis by the data analysis unit 17 can be performed by the batch processing.

First, as shown in FIG. 8, the data analysis unit 17 acquires the target logical formula (search query) and an identification information of the analysis tool specified by the hypothesis verification unit 13 (step B1).

Next, the data analysis unit 17 extracts the parameters constituting the target logical formula and their values (step B2).

Next, the data analysis unit 17 inputs the name of the corresponding logical formula and the observation data for each analysis tool specified by the hypothesis verification unit 13, executes each analysis tool, and attempts to acquire the analysis result. (Step B3).

Next, the hypothesis verification unit 13 determines whether or not the analysis result has been acquired in step B3 (step B4). If the analysis result has not been obtained as a result of the determination in step B3, the hypothesis verification unit 13 determines that the verification has failed (step B7). After that, the hypothesis verification unit 13 outputs this to the outside.

On the other hand, if the analysis result has been obtained as a result of the determination in step B3, the hypothesis verification unit 13 determines whether or not an existing value exists in the parameter of the logical formula corresponding to the analysis result (step B5).

As a result of the determination in step B5, if the existing value does not exist in the parameter of the logical formula corresponding to the analysis result, the hypothesis verification unit 13 determines that the verification is successful. In this case, the hypothesis generation unit adds a logical formula having the value obtained in the analysis result as the parameter value to the observation data (step B7).

On the other hand, as a result of the determination in step B5, if an existing value exists in the parameter of the logical formula corresponding to the analysis result, the hypothesis verification unit 13 determines whether or not the existing value existing in the parameter corresponding to the analysis result match to the values obtained in the analysis result (step B6).

If, as the results of the determination in step B6, the existing value does not match to the values obtained in the analysis result, the hypothesis verification unit 13 determines that the verification is failed. In this case, the hypothesis generation unit 11 adds a logical formula in which the value obtained in the analysis result is the value of the parameter corresponding to the analysis result to the observation data (step B9).

On the other hand, if as the results of the determination in step B6, the existing value matches to the values obtained in the analysis result, the hypothesis verification unit determines that the verification is successful. In this case, the hypothesis generation unit 11 adds a logical formula having the value obtained in the analysis result or the existing value existing in the parameter corresponding to the analysis result as the value of the parameter to the observation data.

[Effects of the Example Embodiment]

As described above, according to the example embodiment, the plurality of hypothesis candidates is integrated to construct the logical formula set, and the logical formula set is verified. Therefore, when selecting a hypothesis candidate worthy of verification from a plurality of hypothesis candidates, the processing load is reduced. Further, the hypothesis candidates to be integrated are a plurality of hypothesis such that it has each different configuration and evaluation value of each hypothesis candidates calculated by evaluation function is the same or best. Therefore, the possibility that an erroneous hypothesis candidate is selected is greatly reduced.

In addition, in the present embodiment, the hypothesis candidates are verified, and only the completely verified hypothesis candidates are output as the final hypothesis. That is, in the example embodiment, the hypothesis is verified, and the hypothesis is corrected by repeating the abductive inference, therefore, it is possible to obtain the completely verified hypothesis based on a facts including the observation data and the analysis result of the data. Further, in the example embodiment, when all the components of the hypothesis are verified, it is possible to obtain a fact-proven conclusion without requiring manual trial and error.

### Specific Example 1

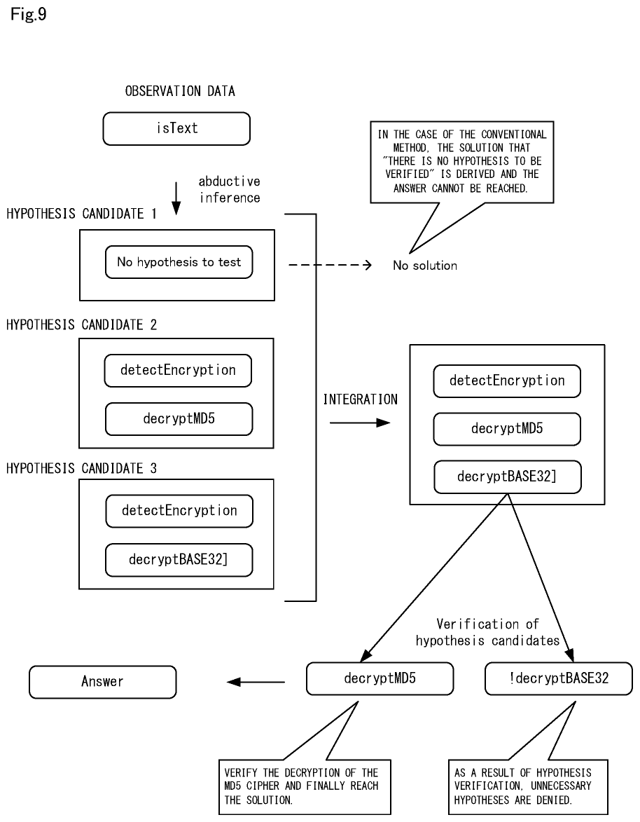

Here, a specific example 1 of the example embodiment will be described with reference to FIG. 9. FIG. 9 is a diagram showing a content of the process in the first specific example according to the example embodiment. The example of FIG. 9 shows an example in which the MD5-encrypted data is decrypted, and a desired character string is acquired by the decryption.

In this example, the input reception unit 19 accepts the input, for example, “isText” and “! is Meaningful” as the observation data.

Then, the hypothesis generation unit 11 derives hypothesis candidate 1 “no hypothesis to be verified”, hypothesis candidate 2 “[detectEncryption], [decryptMD5]”, and hypothesis candidate 3 “[detectEncryption], [decryptBASE32]”, as hypothesis candidates by using the K-best solution output method.

Next, the hypothesis integration unit 12 integrates the logical formulas of each of the hypothesis candidates 1 to 3 as shown in FIG. 9. In the example of FIG. 9, the logical formula of the hypothesis candidate “detect Encryption” is deleted because it overlaps in the hypothesis candidates 2 and 3.

Subsequently, the hypothesis verification unit 13 executes verification on the logical formula set obtained by the hypothesis integration unit 12, determines the truth or falsehood of the logical formula, or inputs a value to the target logical formula. After that, the hypothesis generation unit 11 adds the logical formula that has been determined the truth or falsehood or the target logical formula to the observation data, and derives the hypothesis candidate again. In the example of FIG. 9, as new hypothesis candidates, “decryptMD5” and “!decryptBASE32” are derived, and these are displayed on the screen as the final hypothesis.

As described above, in the example of FIG. 9, even if “there is no hypothesis to be verified” is derived from the observation data, the final hypothesis is derived when other hypothesis candidates are derived. On the other hand, as shown in the background technology column, when only one hypothesis candidate with the lowest proof cost is selected, if only “no hypothesis to be verified” is derived, the final hypothesis will be none. As can be seen from the Specific Example 1, according to the present embodiment, the possibility that an erroneous hypothesis candidate is selected is greatly reduced.

### Specific Example 2

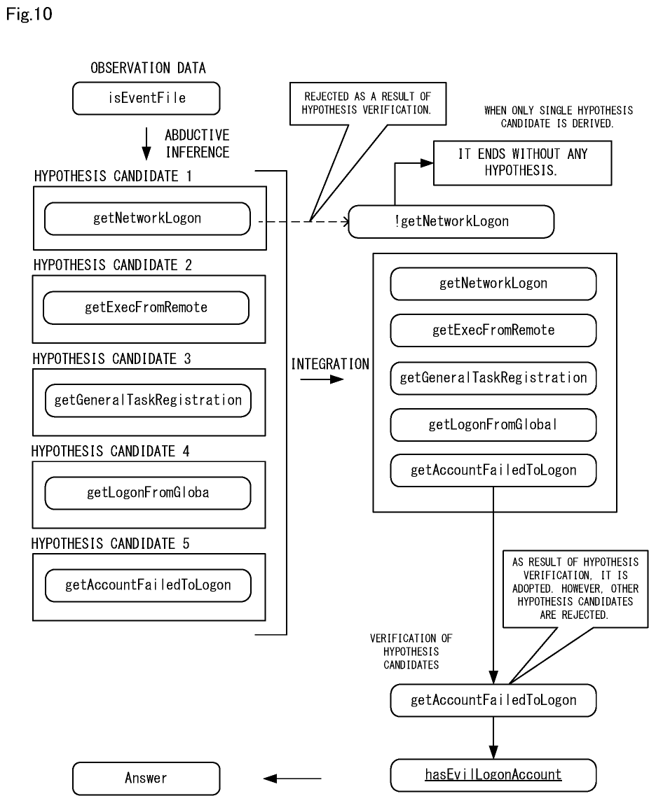

Subsequently, a specific example 2 of the example embodiment will be described with reference to FIG. 10. FIG. 10 is a diagram showing a content of the process in the second specific example according to the example embodiment. The example of FIG. 10 shows an example in which traces of unauthorized login are found in the log file. For example, the input reception unit 19 accepts the input of “isEventFile” as the observation data.

Then, the hypothesis generation unit 11 derives the hypothesis candidates 1 “getNetworkLogon”, the hypothesis candidate 2 “getExecFromRemote”, the hypothesis candidate 3 “getGeneralTaskRegistration”, the hypothesis candidate 4 “getLogonFromGlobal”, and Hypothesis candidate 5 “getAccountFailedToLogon” using the K-best solution output method as hypothesis candidates.

Next, the hypothesis integration unit 12 integrates the logical formulas of each of the hypothesis candidates 1 to 5 as shown in FIG. 9. In the example of FIG. 10, since there are no overlapping hypothesis candidates, all the logical formulas of hypothesis candidates 1 to 5 are integrated.

Subsequently, the hypothesis verification unit 13 executes verification on the logical formula set obtained by the hypothesis integration unit 12, determines truth or falsehood of the logical formula, or inputs a value to the target logical formula. After that, the hypothesis generation unit 11 adds the target logical formula or the logical formula for which truth or falsehood is determined to the observation data and derives the hypothesis candidate again. In the example of FIG. 10, as a result of verification, logical formulas other than “getAccountFailedToLogon” are rejected. Finally “hasEvilLogonAccount” is derived, which is displayed on the screen as a final hypothesis.

As described above, in the example of FIG. 10, hypothesis candidates other than hypothesis candidate 5 are rejected. But as shown in the background technology column, when only one hypothesis candidate with the lowest proof cost is selected, since only the hypothesis candidates that are rejected are derived, there is a possibility that the abductive inference will not execute. For example, when only hypothesis candidate 1 is derived as shown in FIG. 10, as a result of hypothesis verification, “!getNetworkLogon” is derived, and after that, the process ends without deriving the final hypothesis. From this as well, according to the example embodiment, the possibility that an erroneous hypothesis candidate is selected is greatly reduced.

[Program]

It is sufficient for the program according to the present example embodiment to be a program that causes a computer to execute steps A1 to A13 shown in FIG. 7. The hypothesis verification apparatus 10 and the hypothesis verification method according to the present example embodiment can be realized by installing this program in the computer and executing this program. In this case, a processor of the computer functions as the hypothesis generation unit 11, the hypothesis integration unit 12, the hypothesis verification unit 13, the consequential setting unit 14, the data analysis unit 17, the verification result display unit 18, and input reception unit 19, and performs processing.

Also, the consequential storage unit 15 and inference knowledge storage unit 16 are realized by storing a data file constituting these in a storage device, such as a hard disk provided in the computer.

Furthermore, the program according to the example embodiment may be executed by a computer system constructed with a plurality of computers. In this case, for example, each computer may function as one of the hypothesis generation unit 11, the hypothesis integration unit 12, the hypothesis verification unit 13, the consequential setting unit 14, the data analysis unit 17, the verification result display unit 18, and input reception unit 19. Also, the consequential storage unit 15 and inference knowledge storage unit 16 may be constructed on a computer that is different from the computer that executes the program according to the example embodiment.

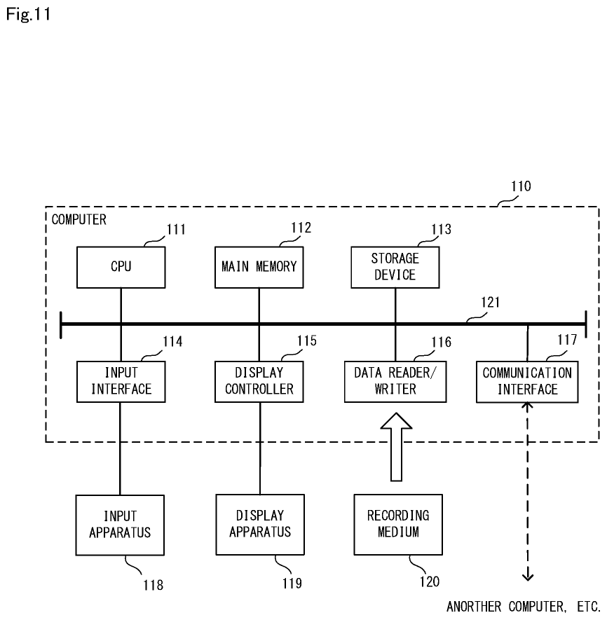

Using FIG. 11, the following describes a computer that realizes the hypothesis verification apparatus 10 by executing the program according to the example embodiment. FIG. 11 is a block diagram showing an example of a computer that realizes the hypothesis verification apparatus according to the example embodiment.

As shown in FIG. 10, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121. Note that the computer 110 may include a GPU (Graphics Processing Unit) or an FPGA (Field-Programmable Gate Array) in addition to the CPU 111, or in place of the CPU 111.

The CPU 111 carries out various types of calculation by deploying the program (codes) according to the example embodiment stored in the storage device 113 to the main memory 112 and executing the codes in a predetermined order. The main memory 112 is typically a volatile storage device, such as a DRAM (dynamic random-access memory). Also, the program according to the present example embodiment is provided in a state where it is stored in a computer-readable recording medium 120. Note that the program according to the present example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input apparatus 118, such as a keyboard and a mouse. The display controller 115 is connected to a display apparatus 119, and controls display on the display apparatus 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the hypothesis verification apparatus 10 according to the present example embodiment can also be realized by using items of hardware that respectively correspond to the components, rather than the computer in which the program is installed. Furthermore, a part of the hypothesis verification apparatus 10 may be realized by the program, and the remaining part of the hypothesis verification apparatus 10 may be realized by hardware.

A part or an entirety of the above-described example embodiment can be represented by (Supplementary Note 1) to (Supplementary Note 15) described below, but is not limited to the description below.

(Supplementary Note 1)

A hypothesis verification apparatus, includes:

a hypothesis generation unit that derives a plurality of hypothesis candidates having a logical formula leading to possible consequences from an observation data represented by a set of logical formulas including one name and one or more parameters by using a knowledge data expressed in the same format as the observation data,

a hypothesis integration unit that integrates the logical formula of each of the hypothesis candidates to construct a logical formula set, and, when there are overlapping logical formula in the logical formula set, select only one of them and delete the rest,

a hypothesis verification unit that sets, when a logical formula including a first parameter having a value obtained from the observation data and a second parameter having no value obtained from the observation data is existing in the logical formula set, the logical formula as a target logical formula, acquire a value of the second parameter based on the observation data and the name of the target logical formula, and input the acquired value of the second parameter into the target logical formula, and on the other hand, when logical formula to be set as the target logical formula is not existing, but if a logical formula that has a value for one or more parameters in advance or has a value obtained by inference knowledge for one or more parameters is existing, determine truth or falsehood of the existing logical formula,

wherein, when the truth or falsehood of the existing logical formula is determined, or the acquired value of the second parameter is input into the target logical formula, the hypothesis generation unit add the logical formula or the target logical formula to the observation data and derives the hypothesis candidates again.

(Supplementary Note 2)

The hypothesis verification apparatus according to Supplementary Note 1, wherein

the hypothesis generation unit derives the plurality of hypothesis candidates having different configurations and evaluation value of each hypothesis candidates calculated by evaluation function is the same or best.

(Supplementary Note 3)

The hypothesis verification apparatus according to Supplementary Note 1 or 2, wherein

the hypothesis generation unit derives the hypothesis candidate composed of a graph structure, and

the hypothesis integration unit construct, based on the graph structure, a graph structure constituting the logical formula set after the deleting.

(Supplementary Note 4)

The hypothesis verification apparatus according to any of Supplementary Notes 1 to 3, wherein

when each of the logical formula constituting the logical formula set has values for all the parameters thereof, the hypothesis generation unit outputs the last derived hypothesis candidate as the final hypothesis.

(Supplementary Note 5)

The hypothesis verification apparatus according to Supplementary Note 4, further includes:

a verification result display unit that displays the final hypothesis as the verification result on a screen.

(Supplementary Note 6)

A hypothesis verification method, includes:

(a) a step of deriving a plurality of hypothesis candidates having a logical formula leading to possible consequences from an observation data represented by a set of logical formulas including one name and one or more parameters by using a knowledge data expressed in the same format as the observation data,

(b) a step of integrating the logical formula of each of the hypothesis candidates to construct a logical formula set, and, when there are overlapping logical formula in the logical formula set, selecting only one of them and deleting the rest,

(c) a step of setting, when a logical formula including a first parameter having a value obtained from the observation data and a second parameter having no value obtained from the observation data is existing in the logical formula set, the logical formula as a target logical formula, acquiring a value of the second parameter based on the observation data and the name of the target logical formula, and inputting the acquired value of the second parameter into the target logical formula, and

(d) a step of determining, when logical formula to be set as the target logical formula is not existing, but if a logical formula that has a value for one or more parameters in advance or has a value obtained by inference knowledge for one or more parameters is existing, truth or falsehood of the existing logical formula,

(e) a step of adding, when the truth or falsehood of the existing logical formula is determined, or the acquired value of the second parameter is input into the target logical formula, the logical formula or the target logical formula to the observation data and deriving the hypothesis candidates again.

(Supplementary Note 7)

The hypothesis verification method according to Supplementary Note 6, wherein

in the step (a), the plurality of hypothesis candidates having different configurations is derived and evaluation value of each hypothesis candidates calculated by evaluation function is the same or best.

(Supplementary Note 8)

The hypothesis verification method according to Supplementary Note 6 or 7, wherein

in the step (a), the hypothesis candidate composed of a graph structure is derived, and

in the step (b), a graph structure constituting the logical formula set is constructed based on the graph structure, after the deleting.

(Supplementary Note 9)

The hypothesis verification method according to any of Supplementary Notes 6 to 8, wherein

in the step (e), when each of the logical formula constituting the logical formula set has values for all the parameters thereof, the last derived hypothesis candidate is output as the final hypothesis.

(Supplementary Note 10)

The hypothesis verification method according to Supplementary Notes 9, further includes:

(f) a step of displaying the final hypothesis as the verification result on a screen.

(Supplementary Note 11)

A computer-readable recording medium in which a program is recorded, the program including an instruction that causes a computer to carry out:

(a) a step of deriving a plurality of hypothesis candidates having a logical formula leading to possible consequences from an observation data represented by a set of logical formulas including one name and one or more parameters by using a knowledge data expressed in the same format as the observation data,

(b) a step of integrating the logical formula of each of the hypothesis candidates to construct a logical formula set, and, when there are overlapping logical formula in the logical formula set, selecting only one of them and deleting the rest,

(c) a step of setting, when a logical formula including a first parameter having a value obtained from the observation data and a second parameter having no value obtained from the observation data is existing in the logical formula set, the logical formula as a target logical formula, acquiring a value of the second parameter based on the observation data and the name of the target logical formula, and inputting the acquired value of the second parameter into the target logical formula, and

(d) a step of determining, when logical formula to be set as the target logical formula is not existing, but if a logical formula that has a value for one or more parameters in advance or has a value obtained by inference knowledge for one or more parameters is existing, truth or falsehood of the existing logical formula,

(e) a step of adding, when the truth or falsehood of the existing logical formula is determined, or the acquired value of the second parameter is input into the target logical formula, the logical formula or the target logical formula to the observation data and deriving the hypothesis candidates again.

(Supplementary Note 12)

The computer-readable recording medium according to Supplementary Note 11, wherein

in the step (a), the plurality of hypothesis candidates having different configurations is derived and evaluation value of each hypothesis candidates calculated by evaluation function is the same or best.

(Supplementary Note 13)

The computer-readable recording medium according to Supplementary Note 11 or 12, wherein

in the step (a), the hypothesis candidate composed of a graph structure is derived, and

in the step (b), a graph structure constituting the logical formula set is constructed based on the graph structure, after the deleting.

(Supplementary Note 14)

The computer-readable recording medium according to any of Supplementary Notes 11 to 13, wherein

in the step (e), when each of the logical formula constituting the logical formula set has values for all the parameters thereof, the last derived hypothesis candidate is output as the final hypothesis.

(Supplementary Note 15)

The computer-readable recording medium according to Supplementary Note 14, wherein

the program further includes an instruction that causes the computer to carry out: (f) a step of displaying the final hypothesis as the verification result on a screen.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the present invention, a possibility of selecting an erroneous hypothesis candidate is reduced without increasing a processing load, in case of selecting a hypothesis candidate worthy of verification from a plurality of hypothesis candidates. The present invention is useful for improving the efficiency of work for clarifying situations or causes such as accidents, crimes, and cyber-attacks. Similarly, the present invention is also useful for analyzing a causes of disasters, system failures, and examining countermeasures.

### REFERENCE SIGNS LIST

10 hypothesis verification apparatus
11 hypothesis generation unit
12 hypothesis integration unit
13 hypothesis verification unit
14 consequential setting unit
15 consequential storage unit
16 inference knowledge storage unit
17 data analysis unit
18 verification result display unit
19 input reception unit
20 display device
110 computer
111 CPU
112 main memory
113 storage device
114 input interface
115 display controller
116 data reader/writer
117 communication interface
118 input apparatus
119 display apparatus
120 recording medium
121 bus

What is claimed is:

1. A hypothesis verification apparatus, comprising:
a hypothesis generation unit configured to derive a plurality of hypothesis candidates having a logical formula leading to possible consequences from an observation data represented by a set of logical formulas including one name and one or more parameters by using a knowledge data expressed in the same format as the observation data,
a hypothesis integration unit configured to integrate the logical formula of each of the hypothesis candidates to construct a logical formula set, and, when there are overlapping logical formula in the logical formula set, select only one of them and delete the rest,
a hypothesis verification unit configured to set, when a logical formula including a first parameter having a value obtained from the observation data and a second parameter having no value obtained from the observation data is existing in the logical formula set, the logical formula as a target logical formula, acquire a value of the second parameter based on the observation data and the name of the target logical formula, and input the acquired value of the second parameter into the target logical formula, and
on the other hand, when logical formula to be set as the target logical formula is not existing, but if a logical formula that has a value for one or more parameters in advance or has a value obtained by inference knowledge for one or more parameters is existing, determine truth or falsehood of the existing logical formula,
wherein, when the truth or falsehood of the existing logical formula is determined, or the acquired value of the second parameter is input into the target logical formula, the hypothesis generation unit add the logical formula or the target logical formula to the observation data and derives the hypothesis candidates again.

2. The hypothesis verification apparatus according to claim 1, wherein
the hypothesis generation unit derives the plurality of hypothesis candidates having different configurations and evaluation value of each hypothesis candidates calculated by evaluation function is the same or best.

3. The hypothesis verification apparatus according to claim 1, wherein
the hypothesis generation unit derives the hypothesis candidate composed of a graph structure, and
the hypothesis integration unit construct, based on the graph structure, a graph structure constituting the logical formula set after the deleting.

4. The hypothesis verification apparatus according to claim 1, wherein
when each of the logical formula constituting the logical formula set has values for all the parameters thereof, the hypothesis generation unit outputs the last derived hypothesis candidate as the final hypothesis.

5. The hypothesis verification apparatus according to claim 4, further comprising:
a verification result display unit configured to display the final hypothesis as the verification result on a screen.

6. A hypothesis verification method, comprising:
deriving a plurality of hypothesis candidates having a logical formula leading to possible consequences from an observation data represented by a set of logical formulas including one name and one or more parameters by using a knowledge data expressed in the same format as the observation data,
integrating the logical formula of each of the hypothesis candidates to construct a logical formula set, and, when there are overlapping logical formula in the logical formula set, selecting only one of them and deleting the rest,
setting, when a logical formula including a first parameter having a value obtained from the observation data and a second parameter having no value obtained from the observation data is existing in the logical formula set, the logical formula as a target logical formula, acquiring a value of the second parameter based on the observation data and the name of the target logical formula, and inputting the acquired value of the second parameter into the target logical formula, and
determining, when logical formula to be set as the target logical formula is not existing, but if a logical formula that has a value for one or more parameters in advance or has a value obtained by inference knowledge for one or more parameters is existing, truth or falsehood of the existing logical formula,
adding, when the truth or falsehood of the existing logical formula is determined, or the acquired value of the second parameter is input into the target logical formula, the logical formula or the target logical formula to the observation data and deriving the hypothesis candidates again.

7. The hypothesis verification method according to claim 6, wherein
in the deriving, the plurality of hypothesis candidates having different configurations is derived and evaluation value of each hypothesis candidates calculated by evaluation function is the same or best.

8. The hypothesis verification method according to claim 6, wherein
in the deriving, the hypothesis candidate composed of a graph structure is derived, and
in the integrating, a graph structure constituting the logical formula set is constructed based on the graph structure, after the deleting.

9. The hypothesis verification method according to claim 6, wherein
in the adding, when each of the logical formula constituting the logical formula set has values for all the parameters thereof, the last derived hypothesis candidate is output as the final hypothesis.

10. The hypothesis verification method according to claim 9, further comprising:
displaying the final hypothesis as the verification result on a screen.

11. A non-transitory computer-readable recording medium in which a program is recorded, the program including an instruction that causes a computer to carry out:
deriving a plurality of hypothesis candidates having a logical formula leading to possible consequences from an observation data represented by a set of logical formulas including one name and one or more parameters by using a knowledge data expressed in the same format as the observation data,
integrating the logical formula of each of the hypothesis candidates to construct a logical formula set, and, when there are overlapping logical formula in the logical formula set, selecting only one of them and deleting the rest,
setting, when a logical formula including a first parameter having a value obtained from the observation data and a second parameter having no value obtained from the observation data is existing in the logical formula set, the logical formula as a target logical formula, acquiring a value of the second parameter based on the observation data and the name of the target logical formula, and inputting the acquired value of the second parameter into the target logical formula, and
determining, when logical formula to be set as the target logical formula is not existing, but if a logical formula that has a value for one or more parameters in advance or has a value obtained by inference knowledge for one or more parameters is existing, truth or falsehood of the existing logical formula,
adding, when the truth or falsehood of the existing logical formula is determined, or the acquired value of the second parameter is input into the target logical formula, the logical formula or the target logical formula to the observation data and deriving the hypothesis candidates again.

12. The non-transitory computer-readable recording medium according to claim 11, wherein
in the deriving, the plurality of hypothesis candidates having different configurations is derived and evaluation value of each hypothesis candidates calculated by evaluation function is the same or best.

13. The non-transitory computer-readable recording medium according to claim 11, wherein
in the deriving, the hypothesis candidate composed of a graph structure is derived, and
in the step (b), a graph structure constituting the logical formula set is constructed based on the graph structure, after the deleting.

14. The non-transitory computer-readable recording medium according to claim 11, wherein
in the adding, when each of the logical formula constituting the logical formula set has values for all the parameters thereof, the last derived hypothesis candidate is output as the final hypothesis.

15. The non-transitory computer-readable recording medium according to claim 14, wherein
the program further includes an instruction that causes the computer to carry out:
displaying the final hypothesis as the verification result on a screen.
